(19) United States
(12) Patent Application Publication
(10) Pub. No.: US 2008/0231964 A1
(43) Pub. Date: Sep. 25, 2008

(54) Composite Layer Having Improved Adhesion, and Fluid Focus Lens Incorporating Same

(75) Inventors: Roel R.M. Tijburg, Geldrop (NL); Piet Van Der Meer, Breda (NL); Godefridus J. Verhoeckx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,411

(22) PCT Filed: Sep. 13, 2006
(86) PCT No.: PCT/IB2006/053264

§ 371 Date: Mar. 11, 2008

Related U.S. Application Data
(60) Provisional application No. 60/718,476, filed on Sep. 19, 2005.

(51) Int. Cl. G02B 1/06; B32B 15/04; B29C 65/00

(52) U.S. Cl. 359/665; 428/469; 156/60

(57) ABSTRACT

A composite material (10, 20) includes a substrate (12, 22) with an electrically conducting metal or metal oxide surface (22B), a layer (14, 24) of an electrically insulating material such as parylene, and an intermediate adhesion-improving metal layer (16, 26) between the substrate and the electrically insulating layer. A fluid focus lens (30) has first and second fluids (32, 34) and first and second electrodes, the first electrode comprising a core (38) of the composite material (10, 20) with the electrically insulating layer (41) positioned between the core (38) and the fluids (32, 34), and the second electrode (50) in contact with the second fluid (34).

This application claims the benefit of U.S. Provisional Application 60/718,476 (Attorney Docket 001697), filed Sep. 19, 2005 and EP Provisional Application 05102398.4 (Attorney Docket NL050252), filed Mar. 24, 2005 and is a continuation-in-part of Application No. PCT/WO/IB2005/051435 (Attorney Docket NL050252), filed May 3, 2005.

This invention relates to a composite material, having a layer of an electrically insulating material on a metal or metallized core, and also relates to a fluid focus lens incorporating the composite material.

Fluid focus lenses are lenses in which light is refracted by a meniscus between two immiscible fluids. Generally, one of the two fluids is electrically insulating and the other is electrically conducting. The shape of the meniscus is variable under the influence of a voltage between two electrodes, one of which is connected to the electrically conducting fluid and the other to a surface which is separated from the fluids by a fluid contact layer. The voltage causes an electrowetting effect whereby the shape of the meniscus is altered.

Such a fluid focus lens is known for instance from PCT published patent application WO-A 03/069380. In this patent application, the lens structure is substantially cylindrical, with the fluids contained within a cylindrically-shaped inner space and surrounded first by the fluid contact layer and then by an annular core of a metallic electrode material which is coated with a layer of an electrically insulating material such as parylene.

Parylene, a tradename for poly-p-xylylene, is generally known for its ability to form thin, conformal deposited coatings on a variety of substrates in a variety of different applications. See, e.g., U.S. Pat. No. 4,173,664.

EP 0785073 describes parylene coatings as having a relatively slick, non-wetting surface that does not easily adhere to other materials, and employs a tantalum layer as an adhesive layer between a parylene coating and another polymer material used to form ink flow channels on ink jet printheads.

U.S. Pat. No. 6,270,872 employs a pressure-sensitive adhesive to adhere a parylene-coated cushioning device to human skin.

U.S. 2005/0112817 describes integrated circuit devices in which interconnects extend through one or more dielectric layers to one or more semiconductor devices. The dielectric layer may comprise silicon dioxide, fluoride-doped silicate glass (FSG), Black Diamond® (a product of Applied Materials of Santa Clara, Calif.), Xerogel, Aerogel, amorphous fluorinated carbon, parylene, BCB (bis-benzocyclobutenes), and SiLK™ (a product of Dow Chemical of Midland, Mich.), and/or other materials, and may be formed by CVD, PECVD, PDL, ALD, PVD, focused ion beam (FIB), Langmuir-Blodgett (LB) molecular assembly, spin-on coating and/or other processes. The interconnects may include copper (Cu), tungsten (W), gold (Au), aluminum, carbon nano-tubes, carbon fullerenes, refractory metals, alloys of these materials and/or other materials, and may be formed by CVD, PECVD, ALD, PVD and/or other processes. The interconnects may also include more than one layer. For example, each interconnect may include an adhesion layer possibly comprising titanium (Ti), titanium nitride (TiN), tantalum (Ta) or tantalum nitride (TaN), silicon carbide (SiC), silicon oxy-carbide (SiOC), a barrier layer possibly comprising titanium nitride (TiN) and/or tantalum nitride (TaN), silicon carbide (SiC), silicon oxy-carbide (SiOC), and a bulk conductive layer comprising copper (Cu), tungsten (W), aluminum (Al), or aluminum alloy.

It is an object of this invention to improve adhesion between the electrically conducting electrode material of the core and an electrically insulating layer of a fluid focus lens.

It is another object of the invention to improve adhesion generally between an electrically conducting material and an electrically insulating layer of a composite material.

In accordance with a first aspect of the invention, there is provided a composite material comprising a substrate and a layer of electrically insulating material on at least a portion of the substrate, the substrate comprising at least a surface layer of an electrically conducting metal or metal oxide, characterized in that the composite material includes an intermediate layer comprising an adhesion-improving metallic material between the substrate and the layer of electrically insulating material, whereby the adhesion between the substrate and the electrically insulating material is improved.

In accordance with a second aspect of the invention, there is provided a fluid focus lens comprising a fluid chamber, first and second immiscible fluids within the fluid chamber, the fluids separated by a meniscus, a first electrode in the form of a core having at least a surface layer of an electrically conducting metal or metal oxide, at least one layer of an electrically insulating material on the core between the core and the first and second fluids in the fluid chamber, and a second electrode in contact with the second fluid, characterized in that an intermediate layer comprising an adhesion-improving metal layer is located between the core and at least a portion of the layer of electrically insulating material, whereby the adhesion between the core and the layer of electrically insulating material is improved.

In accordance with an embodiment of the invention, the metal or metal oxide of the substrate is selected from the group consisting of stainless steel, copper, brass and indium-tin oxide (ITO).

In accordance with another embodiment of the invention, the material of the electrically insulating layer is selected from the group consisting of parylene, silicon dioxide (SiO₂), silicon nitride (Si₃N₄), paraffin, barium titanate and an amorphous fluorocarbon polymer such as Teflon AF1600, a product of Dupont, wherein the preferred material is parylene.

Parylene is preferred because charging effects are absent. Also, parylene can be applied relatively easy as a conformal coating, with a smooth surface and well-controlled thickness. These properties are important for electrowetting performance, since they determine the driving voltage of the final product. Conformality is particularly important where a coating of controlled thickness must be provided on the inside walls of a ring-shaped metal-core.

In accordance with another embodiment of the invention, the intermediate metallic layer comprises at least one metal selected from the group consisting of zinc, lead, copper, indium and chromium. These metals are preferred because they can be applied to the metal core by a galvanic process, which is relatively low-cost.

In accordance with one embodiment of the fluid focus lens aspect of the invention, a fluid contact layer is in contact with the electrically insulating layer on an opposite side from the intermediate metallic layer. Preferably, the fluid contact layer is Teflon AF1600.

The fluid focus lens of the invention may be used alone or in combination with other lenses in a camera, an optical recording apparatus or any other optical equipment. The fluid focus lens may be assembled with further lenses, to obtain an optical path as needed, or even to obtain a zoom lens. Alternatively, the fluid focus lens may be used in a display, such as a reflective display, in which case only one of the substrates needs to be optically transparent. The fluid focus lens may also be used as a sensor.

These and other aspects of the composite material, the fluid focus lens and the method of the invention will be further elucidated with reference to the Figures, in which:

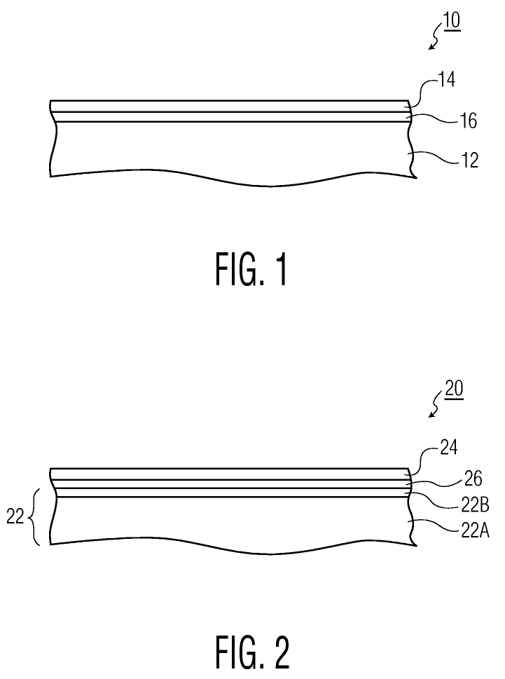

FIG. 1 shows a diagrammatical cross-sectional view of one embodiment of a composite material of the invention;

FIG. 2 shows a diagrammatical cross-sectional view of another embodiment of a composite material of the invention;

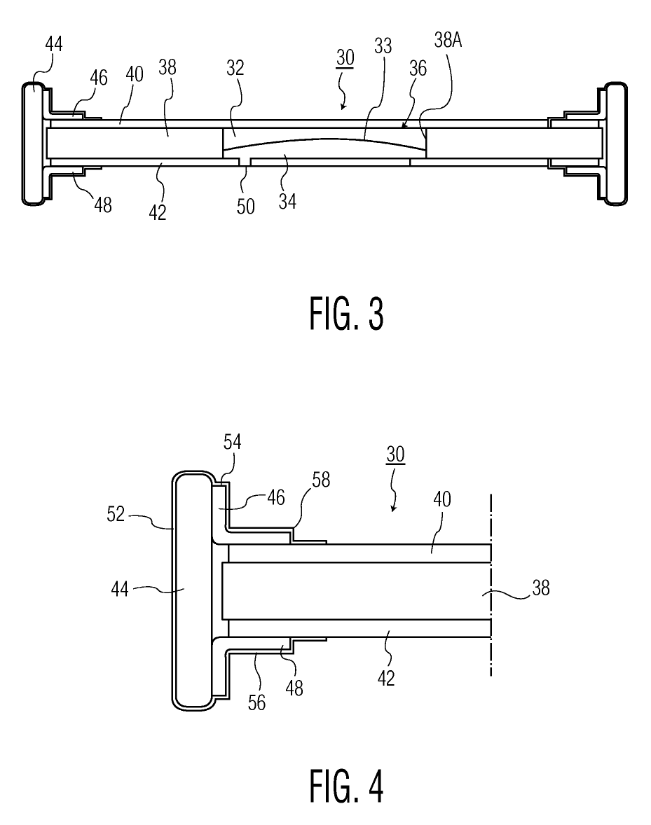

FIG. 3 shows a diagrammatical cross-sectional view of a preferred embodiment of the fluid focus lens of the invention;

FIG. 4 shows a more detailed view of a portion of the left side of the embodiment of FIG. 3; and

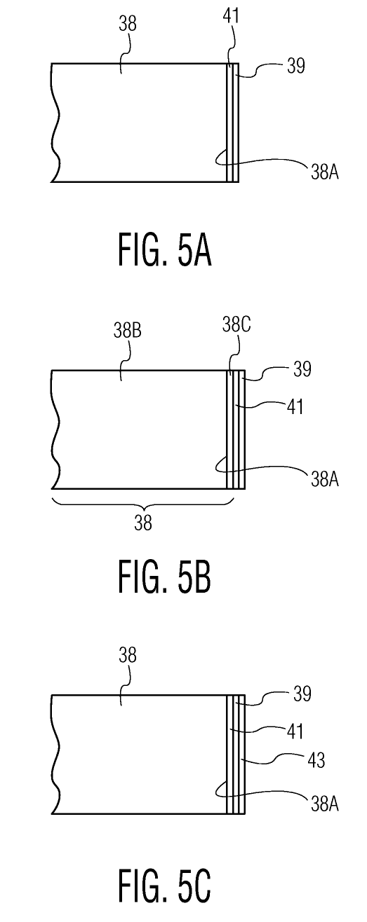

FIGS. 5A, 5B and 5C are more detailed views of a portion of the left side of the core of FIG. 3, showing different combinations of layers on the inner surface of the core.

The Figures are diagrammatic and not drawn to scale. The same reference numbers in different Figures refer to like parts.

Referring now to FIG. 1, there is shown diagrammatically in elevation one embodiment of a composite material 10 of the invention. Substrate 12 is an electrically conducting material such as stainless steel, copper, brass or indium tin oxide (ITO). Supported by substrate 12 is an electrically insulating layer 14, such as parylene, SiO₂, paraffin, barium titanate or Teflon AF1600. Between the substrate 12 and the electrically insulating layer 14 is an adhesion promoting metallic layer 16, such as a thin layer of zinc, lead, copper, indium, chromium or another metal having good adhesion with the substrate 12 as well as the insulating layer 14. The intermediate metallic layer may be applied with standard application techniques such as vapor deposition or electrodeless or galvanic plating. The intermediate metallic layer improves adhesion of the substrate 12 to the insulating layer 10, in particular if the insulating layer is of parylene.

Referring now to FIG. 2, there is shown another embodiment of a composite material 20 of the invention, which is similar to the embodiment of FIG. 1, and includes a substrate 22, an insulating layer 24 and an intermediate adhesion-promoting layer 26. However, in this embodiment, the substrate itself is a composite material of an electrically non-conducting body or core portion 22A, and an electrically conducting surface layer 22B. Electrically conducting surface layer 22B may be a metal or metal oxide such as stainless steel, copper, brass or indium-tin oxide (ITO). The non-conducting core or body 22A may be, for example, polymethylmethacrylate (PMMA), glass or ceramic, provided it satisfies the requirements of the particular application, e.g., adhesion of coatings, coefficient of expansion, smoothness of surface, manufacturing costs, etc.

Referring now to FIG. 3, there is shown a fluid focus lens 30 in accordance with another embodiment of the invention. Lens 30 includes a first electrically insulating fluid 32 and a second electrically conducting fluid 34, both contained within a fluid chamber 36. The first fluid 32 and the second fluid 34 are non-miscible and in contact with each other over a meniscus 33. The first fluid 32 is in this example a silicone oil, an alkane or another suitable electrically insulating fluid. The second fluid 34 is in this example water containing a salt solution or another suitable electrically conducting fluid.

The fluid chamber 36 is formed by sandwiching the annular core 38 between cover plates 40 and 42. The sidewalls of the chamber 36 are formed by the substantially cylindrical inner wall or surface 38A of annular core 38, while the top and bottom walls are formed by optically transparent cover plates 40 and 42.

Surrounding the annular core 38 and forming the outer wall of the device is cylindrical wall part 44. Retaining the core/cover plate assembly within the outer wall are ring-shaped closing members 46 and 48. Annular core 38, which is insulated from liquid 34 in a manner to be described herein, forms a first electrode, while button 50, in contact with liquid 34, forms a second electrode 50 of the fluid focus lens device 30.

Referring now to FIG. 4, a more detailed view of the device 30 of FIG. 3, it can be seen that cylindrical wall part 44 and closing members 46 and 48, each have layers 52, 54 and 56, respectively, of a conductive and ductile material, for example, a metal such as indium or copper, or a conductive composite of a plastic and a metal, e.g., niflon.

Sealing layer 58 overcoats and encapsulates layers 52, 54 and 56, respectively, as well as portions of the cover plates 40 and 42, to complete the assembly.

Sealing layer 58 can be a polymeric coating of rubber, epoxy or the like, as are known per se as protective coatings. However, since layers 52, 54 and 56 are conductive, it is preferred that the sealing layer 58 be conductive as well, e.g., a metal. This allows the formation of a package that is hermetically sealed and not prone to diffusion of air, water or other fluids. Moreover, the metal sealing layer 58 can be formed by electroplating or electrogalvanizing, which is advantageous, inter alia, in that it can be carried out at three-dimensional surfaces, e.g., by immersion of the package in a bath.

FIGS. 5A-C are more detailed views of a portion of the left side of the annular core 38, including inner wall 38A. In the embodiment of FIG. 5A, annular core 38 is of an electrically conductive material, and inner wall 38A is coated with a layer 39 of an insulating material such as parylene. A relatively thin intermediate adhesion-promoting metallic layer 41 is interposed between inner wall 38A and insulating layer 39.

The thin intermediate metallic layer 41 may be applied over all or part of the core 38. The metal of the intermediate metallic layer 41 may be Zn, Pb, Cu, In, Cr or another metal having good adhesion with both the core 38 and the insulating layer 39.

In general, the intermediate metallic layer 41 should be relatively thin (<5 microns) and smooth. The intermediate metallic layer 41 may be applied with standard application techniques such as electroplating, electrodeless plating, chemical vapor deposition, sol-gel deposition, sputtering, or combinations of any such deposition methods are possible, although electroplating is preferred.

The intermediate metallic layer 41 improves adhesion of the core 38 to the insulating layer 39, in particular if the insulating layer is of parylene. The fluid focus lens of the present invention need not, however, rely upon a parylene layer: any insulating layer material such as paraffin, silicon dioxide, barium titanate, or an amorphous fluorocarbon polymer such as Teflon AF1600 may be used.

In the embodiment of FIG. 5B, annular core 38 is itself a composite material, made of an electrically insulating core material, and a surface layer of an electrically conductive material, such as a metal or metal oxide. One possible combination which has been used is polymethylmethacrylate (PMMA) coated with indium-tin oxide (ITO). As in the previous embodiment, inner wall 38A is coated with a layer 39 of an insulating material such as parylene, and an intermediate adhesion-promoting metallic layer 41 is interposed between inner wall 38A and insulating layer 39. The adhesion-promoting layer 41 could also act as conductor if a non-conducting core was used.

The embodiment of FIG. 5C is similar to that of FIG. 5A, except that an additional electrically insulating fluid contacting layer 43. The fluid contact layer 43 is preferably formed from an amorphous fluorocarbon polymer such as Teflon AF1600 and applied, e.g., by dipcoating. Alternatives are also possible, such as Cytop, an amorphous fluoropolymer from Asahi Glass Co.

The invention has necessarily been described in terms of a limited number of embodiments. From this description, other embodiments and variations of embodiments will become apparent to those skilled in the art, and are intended to be fully encompassed within the scope of the invention and the appended claims.

1. A composite material (10, 20) comprising a substrate (12, 22) and a layer (14, 24) of electrically insulating material on at least a portion of the substrate (12, 22), the substrate (12, 22) comprising at least a surface layer (22B) of an electrically conducting metal or metal oxide, characterized in that the composite material (10, 20) includes an intermediate layer (16, 26) comprising an adhesion-promoting metallic material between the substrate (12, 22) and the layer (14, 24) of electrically insulating material, whereby the adhesion between the substrate (12, 22) and the layer (14, 24) of electrically insulating material is improved.

2. A composite material as claimed in claim 1, wherein the substrate consists essentially of metallic material.

3. A composite material as claimed in claim 1, wherein the metallic material of the substrate is selected from the group consisting of stainless steel, copper, brass and indium-tin oxide (ITO).

4. A composite material as claimed in claim 1, wherein the layer of electrically insulating material is selected from the group consisting of parylene, SiO₂, paraffin, barium titanate, and an amorphous fluorocarbon polymer.

5. A composite material as claimed in claim 4, wherein the electrically insulating material is parylene.

6. A composite material as claimed in claim 1, wherein the adhesion-promoting metallic material of the intermediate layer is at least one of the metals selected from the group consisting of Zn, Pb, Cu, In, Cr.

7. A fluid focus lens (30) comprising a fluid chamber (36), first and second immiscible fluids (32, 34) within the fluid chamber (36), the fluids (32, 34) separated by a meniscus (33), a first electrode in the form of a core (38) having at least a surface layer (38C) of an electrically conducting metal or metal oxide, at least one layer (39) of an electrically insulating material on the core (38) between the core (38) and the first and second fluids (32, 34) in the fluid chamber, and a second electrode (50) in contact with the second fluid (34), characterized in that an intermediate layer (41) comprising an adhesion-promoting metallic material is located between the core (38) and at least a portion of the layer (39) of electrically insulating material, whereby the adhesion between the core (38) and the layer of electrically insulating material (39) is improved.

8. A fluid focus lens as claimed in claim 7, wherein the substrate consists essentially of metallic material.

9. A fluid focus lens as claimed in claim 8, wherein the metallic material of the substrate is selected from the group consisting of stainless steel, copper, brass and indium-tin oxide (ITO).

10. A fluid focus lens as claimed in claim 7, wherein the layer of electrically insulating material is selected from the group consisting of parylene, SiO₂, paraffin, barium titanate, and an amorphous fluorocarbon polymer.

11. A fluid focus lens as claimed in claim 10, wherein the electrically insulating material is parylene.

12. A fluid focus lens as claimed in claim 7, wherein the adhesion-promoting metallic material of the intermediate layer is selected from the group consisting of Zn, Pb, Cu, In, Cr.

13. A fluid focus lens as claimed in claim 7, wherein a fluid contact layer (43) is located on at least a portion of the electrically insulating layer on an opposite side from the intermediate metallic layer.

14. A fluid focus lens as claimed in claim 13, wherein the fluid contact layer is an amorphous fluorocarbon polymer.

15. A component comprising a substrate (12, 22) and a layer (14, 24) of electrically insulating material on at least a portion of the substrate (12, 22), the substrate (12, 22) comprising at least a surface layer (22B) of an electrically conducting material, wherein the composite material (10, 20) includes an intermediate layer (16, 26) comprising an adhesion-promoting metallic material between the substrate (12, 22) and the layer (14, 24) of electrically insulating material, whereby the adhesion between the substrate (12, 22) and the layer (14, 24) of electrically insulating material is improved.

16. A component as claimed in claim 15, wherein the component is a component of an optical system.

17. A component as claimed in claim 16, wherein the component is a component of a fluid focus lens (30).

18. A method for improving adhesion between a substrate (12, 22) comprising at least a surface layer (22B) of an electrically conducing material and a layer (14, 24) of electrically insulating material, comprising forming between the substrate (12, 22) and the layer (14, 24) of electrically insulating material, an intermediate layer (16, 26) comprising an adhesion-promoting metallic material.

19. A method as claimed in claim 18 comprising forming the surface layer (22B) of metal or metal oxide.
